(19) United States
(12) Patent Application Publication
(10) Pub. No.: US 2011/0014834 A1
(43) Pub. Date: Jan. 20, 2011

(54) Prefabricated Fabric for Liquid Molding Composite Material and Preparation Method Thereof

(75) Inventors: Xiaosu Yi, Beijing (CN); Xuefeng An, Beijing (CN); Ming Zhang, Beijing (CN)

Correspondence Address: STERNE, KESSLER, GOLDSTEIN & FOX P.L.L.C., 1100 NEW YORK AVENUE, N.W., WASHINGTON, DC, 20005, US

(73) Assignee: Beijing Institute of Aeronautical Materials, AVIC I, Beijing (CN)

(21) Appl. No.: 12/503,590

(22) Filed: Jul. 15, 2009

(51) Int. Cl. B32B 27/12; B05D 5/10

(52) U.S. Cl. 442/71; 427/208.2

(57) ABSTRACT

The present invention is in the field of composite material manufacturing technology, and relates to a prefabricated fabric for liquid molding composite material and a preparation method thereof. The prefabricated fabric comprises a basal fiber fabric, which is characterized in that one or two surface(s) of the basal fiber fabric is(are) conglutinated with a toughening layer. The method for preparing the prefabricated fabric comprises the steps of conglutination of toughening layer, and conglutination of tackifying layer. The prefabricated fabric has both the interlaminar selective toughening and tackifying functions, and realizes the high toughness modification of the composite material while keeping the composite material liquid molding processibility and the good tackifying performance.

### TECHNICAL FIELD

The present invention is in the field of composite material manufacturing technology, and relates to a prefabricated fabric for liquid molding composite material and a preparation method thereof.

### BACKGROUND ART

At present, composite material mainly develops in the direction of high performance and low cost. As to the current advanced composite material manufacturing technology with low cost, it mainly includes liquid molding technology represented by resin transfer molding (RTM), resin film infusion (RFI) and etc. The main advantage of RTM or RFI resides in that it can manufacture parts with complicated structure and high fiber volume content, while keeping a relatively high structural design efficiency.

As far as an advanced composite material is concerned, toughness determines damage tolerance of the composite material, and the damage tolerance is directly relevant to design limit of the composite material, accordingly the reduction in toughness of the composite material will lead to a reduced design allowance, which directly affects the weight relief efficiency of the composite structure. In order to enable a resin to fully infiltrate a preform, RTM or RFI resin system must have a very low viscosity. However, a low-viscosity resin is generally brittle, and is also difficult to toughen by adding a high-molecular-weight component via a conventional technique, thus the contradiction between low viscosity of resin and toughness of composite material in liquid molding technology draws the main attention of researchers. It is a technical problem under universal attention in the field of composite material as how to obtain a RTM-moldable composite material with a high damage tolerance.

Conventional toughening technology involves introducing high-molecular-weight, high-toughness components such as rubber, thermoplastic resin and etc. in a relatively great quantity into a low-toughness matrix (which is mostly thermosetting resin), and forming a diphase or multiphase structure during curing to increase toughness of the resin in its entirety. Thus, this toughening technology is “in situ”, and belongs to an “integral” toughening technology in spatial position, and it uniformly occurs in any spatial position throughout the entire system. Obviously, just due to such integral toughening treatment, the viscosity of the resin matrix is sharply increased, so that it is impossible to carry out a liquid molding process.

The Chinese patent application No. 200610099381.9 entitled “toughening composite material laminates and method for making same” sets forth a so-called “ex situ” method for selective local toughening of interlayer sites of a composite material laminate, which can be used in a prepreg composite system to notably improve its impact damage tolerance. This method is featured in that the whole toughening treatment is limited to the interlayer, and exerts no obvious influence on the interior of the layers.

When manufacturing a composite part by using RTM or RFI technology, various prefabricated fabrics are firstly bonded with tackifying agent (or sewed) to form a preform, then the preform is fully impregnated with resin by injection or impregnation, and further cured by heating to form a composite part.

A tackifier (bining agent) is generally in the form of solution. In use, it is uniformly coated onto a fabric, and after volatilization of solvent therein, a tackified preform is obtained. At present, this commonly used tackification process has the following draw-backs: (1) solvent remained in the preform may cause defect into the final product; (2) the surface of reinforcement fibers generally has been optimized for a resin matrix, to thereby improve interfacial property, then, when the surface of the fibers is coated with tackifier, it may affect the bonding of fiber-matrix interfaces; (3) even if a non-solvent dry powder tackifier is used, the technical problems in terms of distribution form and distribution state of the tackifier on surface of the fabric as well as design, construction and control of in-layer diffusion of the tackifier still exist, and there are no unified knowledge about these problems and countermeasure for solving them for the moment.

### CONTENTS OF THE INVENTION

The object of the present invention is to provide a prefabricated fabric for liquid molding composite material and a preparation method thereof, wherein the prefabricated fabric has both the interlaminar selective toughening and tackifying functions, and realizes the high toughness modification of the composite material while keeping the composite material liquid molding processibility and the good tackifying performance.

The technical solution of the present invention is described as follows: a prefabricated fabric for liquid molding composite material, comprising a basal fiber fabric, wherein the fiber is selected from the group consisting of glass fiber, carbon fiber, aramid fiber, basalt fiber, natural plant fiber or a mixture of these fibers, and the fabric is in a structure selected from the group consisting of unidirectional fabric, plain fabric, satin fabric, twill fabric, non-weft fabric, non-woven fabric or non-crimp fabric; which is characterized in that: one or two surface(s) of the basal fiber fabric is(are) conglutinated with a toughening layer, wherein the toughening layer comprises one of the following substances: thermoplastic resins, including polyetherketone, polysulfone, polyethersulfone, thermoplastic polyimide, polyetherimide, polycarbonate, polyphenylene oxide, polyamide, or a mixture of one of these thermoplastic resins with one of the following thermosetting resins: epoxy resin, bismaleic imide resin, thermosetting polyimide resin, polybenzoxazine resin, phenolic resin, cyanate resin, unsaturated polyester resin, wherein the thermosetting resin accounts for 5-50% by weight of the mixture; the toughening layer has an areal weight of 1-50 g/m², and a thickness of 1-50 μm; the toughening layer is conglutinated continuously or discretely in a certain pattern, and covers the surface of the basal fiber fabric by a percentage of ≧50%.

A method for preparing the prefabricated fabric for liquid molding composite material, comprising the steps of:

1. Conglutination of Toughening Layer

1.1 Preparing a precursor material of toughening layer by making toughening component into the form of solution, powder, film, hot-melt adhesive or fabric, which independently exists or adheres to a supporting paper or a supporting fabric;

1.2 Conglutinating the precursor material of toughening layer onto one or two surface(s) of a basal fiber fabric by using the following method: solution coating method for solution; hot-melt coating or powder coating method for powder; film-laminating method for film; hot-melt coating or hot-press transfer method for hot-melt adhesive; fabric laminating or hot-melt coating method for fabric; to thereby form a continuous toughing layer or a discrete toughening layer in a certain pattern;

2. Conglutination of Tackifying Layer

2.1 Preparing a precursor material of tackifying layer by making tackifier into the form of solution, powder, film or hot-melt adhesive, which independently exists or adheres to a supporting paper or a supporting fabric;

2.2 Conglutinating the precursor material of tackifying layer onto one or two surface(s) of a basal fiber fabric by using the following method: solution coating method for solution; hot-melt coating or powder coating method for powder; film-laminating method for film; hot-melt coating or hot-press transfer method for hot-melt adhesive; to thereby form a discrete tackifying layer in a certain pattern.

The present invention has the following advantages: the prefabricated fabric has both the interlaminar selective toughening and tackifying functions, and realizes the high toughness modification of the composite material while keeping the composite material liquid molding processibility and the good tackifying performance.

The preparation method of the present invention is featured by separating a high-molecular-weight, high-toughness toughening component from a liquid molding resin matrix, rather than directly mixing them to form a high-viscosity system. By using a fabric as support of toughening component, and applying the toughening component onto surface of a preform of the fabric in advance, the injection stage of liquid molding process is only directed to non-toughened low-viscosity resin matrix, which thereby can ensure the implementation of injection and full impregnation of the preform.

The preparation method of the present invention is also featured by separating the function of the in-layer material that determines the permeability of resin from the function of the interlaminar material that determines the toughness. The toughening component is only distributed in the interlayer, and it co-cures with the resin matrix as principal component which enters by injection during liquid molding process, to form a separate phase structure, which thereby results in an improved interlaminar toughness. Meanwhile, the fabric still substantially retains its original permeability in the inside, which thereby ensures that the resin matrix as principal component can smoothly and fully impregnate the reinforcement fibers in the course of liquid molding.

The preparation method of the present invention is also featured by discrete surface tackifying of the fabric, i.e., the tackifier does not impregnate the entire preform in the form of solution anymore, but is distributed on surface of the fabric in the form of discrete points, which ensures that the tackified fabric has excellent binding effects in terms of cutting, overlaying, self-support molding and etc., and meanwhile is able to reduce the amount of the tackifier as much as possible, and also minimize the influence thereof on the fabric-resin matrix interface.

The preparation method of the present invention is also featured by distributing the toughening layer and the tackifying layer on surface of the fabric in discrete form, and forming a pre-designed pattern, to thereby ensure: (1) the toughening component and the tackifying component are present in sufficient amounts in the interlayer; (2) the toughening layer and the tackifying layer in reticulate design have enough permeability, and would not obviously inhibit the flow of the resin matrix as principal component in perpendicular to the interlayer; (3) the fabric retains enough deformability in both longitudinal and transverse directions, and can be subjected to cutting, overlaying and preforming to form a preform having a designated shape.

### DESCRIPTION OF FIGURES

FIG. 1 exemplifies a distribution pattern of toughening component and tackifying component on surface of a prefabricated fabric: distribution on surface of fabric;

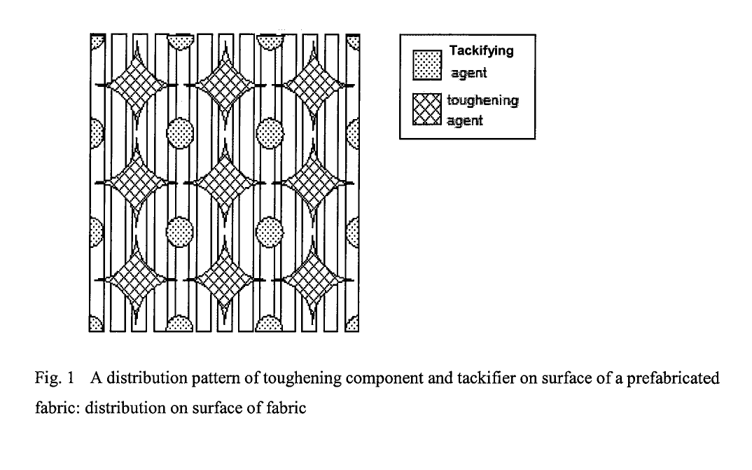

FIG. 2 exemplifies another distribution figure of toughening component and tackifying component distributed on surface of a prefabricated fabric: distribution on surface of monofilament;

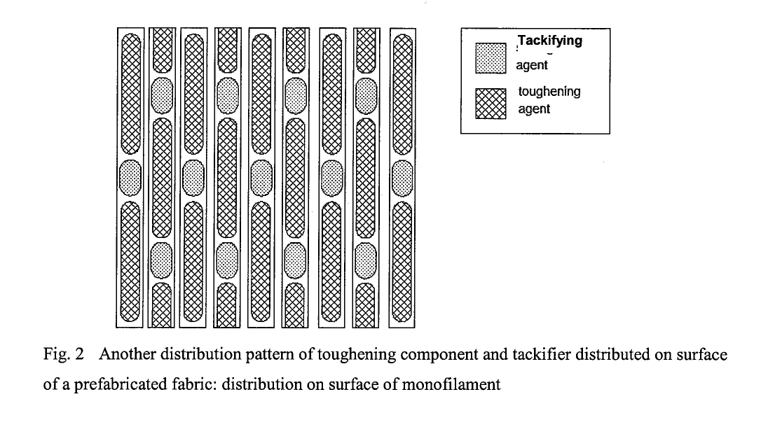

FIG. 3 exemplifies an outside pattern of a typical toughening layer.

### MODE OF CARRYING OUT THE INVENTION

The present invention is further described below in detail. A prefabricated fabric for liquid molding composite material, comprising a basal fiber fabric, wherein the fiber is selected from the group consisting of glass fiber, carbon fiber, aramid fiber, basalt fiber, natural plant fiber or a mixture of these fibers, and the fabric is in a structure selected from the group consisting of unidirectional fabric, plain fabric, satin fabric, twill fabric, non-weft fabric, non-woven fabric or non-crimp fabric; which is characterized in that: one or two surface(s) of the basal fiber fabric is(are) conglutinated with a toughening layer, wherein the toughening layer comprises one of the following substances: thermoplastic resins, including polyetherketone, polysulfone, polyethersulfone, thermoplastic poyimide, polyetherimide, polycarbonate, polyphenylene oxide, polyamide, or a mixture of one of these thermoplastic resins with one of the following thermosetting resins: epoxy resin, bismaleic imide resin, thermosetting polyimide resin, polybenzoxazine resin, phenolic resin, cyanate resin, unsaturated polyester resin, wherein the thermosetting resin accounts for 5-50% by weight of the mixture; the toughening layer has an areal weight of 1-50 g/m², and a thickness of 1-50 μm; it is recommended that the toughening layer has an areal weight of 10-30 g/m², and a thickness of 10-30 μm. The toughening layer is conglutinated continuously or discretely in a certain pattern, and covers the surface of the basal fiber fabric by a percentage of ≧50%.

In order to further increase the tackifying performance of the prefabricated fabric, a tackifying layer is uniformly conglutinated onto a surface, on which a toughening layer has been conglutinated or not, of the basal fiber fabric. The tackifying layer comprises one of the following substances: thermosetting resins, including epoxy resin, bis maleic imide resin, thermosetting polyimide resin, polybenzoxazine resin, phenolic resin, cyanate resin, unsaturated polyester resin, or a mixture of one of these thermosetting resins with rubber particles, wherein the rubber particles account for 1-50% by weight of the mixture; the areal weight of the tackifying layer is 1-30% that of the basal fiber fabric. The tackifying layer is conglutinated discretely in a certain pattern.

A method for preparing the prefabricated fabric for liquid molding composite material, comprising the steps of:

1. Conglutination of Toughening Layer

1.1 Preparing a precursor material of toughening layer by making toughening component into the form of solution, powder, film, hot-melt adhesive or fabric, which independently exists or adheres to a supporting paper or a supporting fabric;

1.2 Conglutinating the precursor material of toughening layer onto one or two surface(s) of a basal fiber fabric by using the following method: solution coating method for solution; hot-melt coating or powder coating method for powder; film-laminating method for film; hot-melt coating or hot-press transfer method for hot-melt adhesive; fabric laminating or hot-melt coating method for fabric; to thereby form a continuous toughing layer or a discrete toughening layer in a certain pattern;

2. Conglutination of Tackifying Layer

2.1 Preparing a precursor material of tackifying layer by making tackifier into the form of solution, powder, film or hot-melt adhesive, which independently exists or adheres to a supporting paper or a supporting fabric;

2.2 Conglutinating the precursor material of tackifying layer onto one or two surface(s) of a basal fiber fabric by using the following method: solution coating method for solution; hot-melt coating or powder coating method for powder; film-laminating method for film; hot-melt coating or hot-press transfer method for hot-melt adhesive; to thereby form a discrete tackifying layer in a certain pattern.

The present invention is explained in more detail by way of the following examples.

### Example 1

Preparation of toughening layer: polyethersulfone (PES) was dissolved in tetrahydrofuran (THF) to obtain a 5% solution. The obtained PES solution was uniformly coated onto a supporting paper by using a film scraper, to form a toughening film after volatilization of the solvent. By adjusting the height of the film scraper, the areal weight of the toughening film was controlled to be 20 g/m². The toughening film was edged and rolled, to obtain a continuous PES film of about 900 mm in width.

A SW280 plain glass fabric was laid on a stainless conveying belt, and the PES film was unrolled and adsorbed on upper surface of the glass fabric. The fabric covered with the PES film moved forward, and went through a THF spray device, whereby the PES film was dissolved by THF and closely stuck to the surface of the glass fabric, and then shrank along with volatilization of the solvent, to leave out gaps between adjacent glass filament bundles. After volatilization of the solvent, the fabric laminated with the toughening layer was rolled.

Preparation of tackifying layer: E54 epoxy resin was dissolved in acetone, to obtain a 5% solution. The glass fabric laminated with a PES toughening layer as prepared in the above step was laid on a stainless conveying belt, with the surface free of toughening layer positioned upward. The epoxy resin solution was sprayed with a spray gun onto the surface of the glass fabric, and the solution droplets were atomized and dried in the course of spraying, and then adsorbed in the form of epoxy resin droplets on the surface of the glass fabric. By adjusting the speed of the conveying belt, the areal weight of the epoxy resin was controlled to be 2.5% that of the SW280 plain glass fabric. Thus, a prefabricated fabric was prepared.

The fabric prepared was cut and overlaid to combine into a preform, and loaded in a mold. Then, E54 epoxy resin as matrix resin was injected into the mold by using an VARI process, followed by curing according to a standard curing cycle of resin system, to thereby obtain the desired composite product.

### Example 2

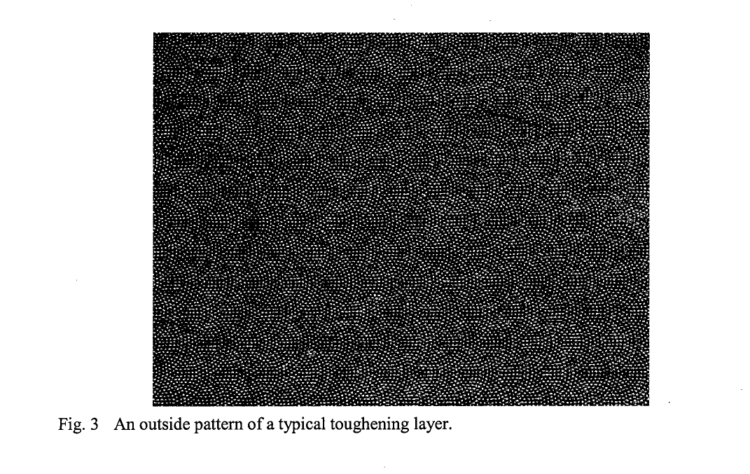

Preparation of toughening layer: polyetherimide (PEI) resin powder was added to water in which an emulsifying agent and a thickening agent were dissolved, to obtain a slurry having a viscosity of about 10 000 cPoise and a solids content of about 35%. The slurry was coated on a G827 unidirectional carbon fiber fabric by passing through a circular net engraved with a designated pattern on a paste point coating machine, followed by passing through a high temperature oven of 380° C., to make the PEI powder be melt-conglutinated on the surface of the carbon fiber fabric. By designing the pattern of the circular net, the areal weight of the toughening layer was controlled to be 10 g/m². Thus, a fabric laminated with a toughening layer was obtained. (The pattern of a typical toughening layer was shown in FIG. 3).

Preparation of tackifying layer: carboxyl-terminated butadiene-acrylonitrile rubber (CTBN) particles and AG80 epoxy resin were mixed in a weight ratio of 5:100, and then the resultant mixture was subjected to low temperature freezing and crushing to form tackifier particles. Through a vibrating screen on a horizontal reciprocating powder spreading machine, the tackifier particles were uniformly spread onto a surface, which was free of the toughening agent, of the carbon fiber fabric laminated with the PEI toughening layer, in an areal weight that was 5% that of the G827 unidirectional carbon fiber fabric. After passing through an oven of 150° C., the tackifier particles were melt-conglutinated on the surface of the fabric, whereby one tackifying layer was laminated onto the fabric. Thus, a prefabricated fabric was prepared.

The fabric prepared was cut and overlaid to combine into a preform, and loaded in a mold. Then, 6421 bismaleic imide resin as matrix resin was injected into the mold by using an RTM process, followed by curing according to a standard curing cycle of resin system, to thereby obtain the desired composite product.

### Example 3

Preparation of toughening-tackifying bifunctional layer: a poly(aryl ether ketone) (PAEK) resin was dissolved in tetrahydrofuran (THF), to obtain a 20% solution. The solution was printed onto a G827 unidirectional carbon fiber fabric by using a gravure printing machine, to form a designated pattern. By designing the depth and figure of the concaves, the areal weight of the toughening layer was controlled to be 15 g/m². While the PAEK was still in liquid state before complete volatilization of the solvent, CTBN/AG80 tackifier particles were quantitatively spread through a vibrating screen onto the surface of the fabric. After volatilization of the solvent, the tackifier particles adhered to naked fiber surface were removed by a ventilator, while the tackifier particles adhered to the surface of the toughening agent droplets were conglutinated by the PAEK on the fabric. The size of screen mesh and the feeding speed were controlled to make the areal weight of the tackifier be 6% that of the G827 unidirectional carbon fiber fabric. After pressing with a roll at 80° C., a prefabricated fabric was prepared.

The fabric prepared was cut and overlaid to combine into a preform. Then, a polybenzoxazine film and the preform were loaded together in a mold, and cured in an autoclave according to a standard curing cycle of resin system, to thereby obtain the desired RFI composite product.

### Example 4

Preparation of a precursor material of toughening layer: a polyethersulfone (PES) resin was melt-spun, to obtain a tow having a monofilament density of about 20 dt, and a tow linear density of about 400 dt. The PES tow was woven into a sparse plain fabric, having an areal weight of 20 g/m².

Preparation of a precursor material of tackifying layer: by using a hot-melt coater machine, an AG80 epoxy resin was made into a film supported on a supporting paper, having an areal weight 2% that of a G3186 carbon fiber satin fabric.

On a hot-melt impregnation machine, the G3186 carbon fiber satin fabric was surface-covered with the PES fabric, and then the precursor material of tackifying layer was laminated on upper and lower surfaces of the fabric, followed by pressing with a roll at 80° C. After removal of the supporting paper, a prefabricated fabric was prepared.

The fabric prepared was cut and overlaid to combine into a preform, and loaded in a mold. Then, 5284 epoxy resin as matrix resin was injected into the mold by using an RTM process, followed by curing according to a standard curing cycle of resin system, to thereby obtain the desired composite product.

### Example 5

Preparation of a toughening-tackifying bifunctional precursor material: a polyethersulfone (PES) resin and a polybenzoxazine (PBO) resin were mixed in a weight ratio of 65:35, and heated to 130° C. while stirring to obtain a eutectic. The eutectic was subjected to a low-temperature crushing to obtain toughening-tackifying bifunctional particles. Through a vibrating screen on a horizontal reciprocating powder spreading machine, the toughening-tackifying bifunctional particles were uniformly spread onto a backing fabric, in an areal weight of 25 g/m², and then pressed with a roll at 80° C.

On a hot-melt impregnation machine, the toughening-tackifying bifunctional precursor material was laminated onto an upper surface of a EW220 glass fiber fabric, and then the toughening-tackifying bifunctional particles were transferred to the surface of the glass fabric by hot pressing with a roll at 100° C., whereby a prefabricated fabric was prepared.

The fabric prepared was cut and overlaid to combine into a preform, and loaded in a mold. Then, a polybenzoxazine resin as matrix resin was injected into the mold by using an RTM process, followed by curing according to a standard curing cycle of resin system, to thereby obtain the desired composite product.

### Example 6

Simultaneous preparation of toughening layer and tackifying layer: a polyetherimide (PEI) was dissolved in tetrahydrofuran (THF), to obtain a 35% solution. Carboxyl-terminated butadiene-acrylonitrile rubber (CTBN) particles and AG80 epoxy resin were mixed in a weight ratio of 5:100, and dissolved in acetone to obtain a 50% solution. On a gravure printing machine equipped with two rolls, the PEI solution was printed onto a G827 unidirectional carbon fiber fabric by using a first concave roll, to form a designated pattern, wherein the toughening layer was controlled to have an areal weight of 15 g/m² by designing the depth and figure of the concaves. Then, the CTBN/AG80 tackifier solution was printed onto the G827 unidirectional carbon fiber fabric by using a second concave roll, to form a designated pattern, wherein the tackifying layer was controlled to have an areal weight 6% that of the G827 unidirectional carbon fiber fabric by designing the depth and figure of the concaves. After fully volatilizing the solvent by passing through a low temperature oven of 80° C., a prefabricated fabric was prepared.

The fabric prepared was cut and overlaid to combine into a preform. Then, a 5284 epoxy resin film and the preform were loaded together in a mold, and cured in an autoclave according to a standard curing cycle of resin system, to thereby obtain the desired RFI composite product.

### Example 7

Preparation of toughening layer: a polyamide (PA) emulsion polymerization powder and unsaturated polyester were uniformly mixed in a ratio of 75:25, to obtain a colloidal solution. The obtained colloidal solution was uniformly coated onto an upper surface of a flax fiber fabric by using a film scraper, while the areal weight of the coating was controlled to be 20 g/m² by adjusting the height of the film scraper, whereby a toughening layer was laminated onto the fabric. The toughening layer was protected by covering with a release paper.

Preparation of tackifying layer: E54 epoxy resin was dissolved in acetone, to obtain a 5% solution. The flax fabric laminated on one surface with the toughening layer as prepared in the above step was laid on a stainless conveying belt, with the surface free of toughening layer positioned upward. The epoxy resin solution was sprayed with a spray gun onto the surface of the flax fabric, and the solution droplets were atomized and dried in the course of spraying, and then adsorbed in the form of epoxy resin droplets on the surface of the flax fabric. By adjusting the speed of the conveying belt, the areal weight of the epoxy resin was controlled to be 10% that of the flax fabric. Thus, a prefabricated fabric was prepared.

The fabric prepared was cut and overlaid to combine into a preform, and loaded in a mold. Then, an unsaturated polyester as matrix resin was injected into the mold by using an VARI process, followed by curing according to a standard curing cycle of resin system, to thereby obtain the desired composite product.

1. A prefabricated fabric for liquid molding composite material, comprising:
a basal fiber fabric, wherein the fiber is selected from the group consisting of glass fiber, carbon fiber, aramid fiber, basalt fiber, natural plant fiber and a mixture of these fibers, and the fabric is in a structure selected from the group consisting of unidirectional fabric, plain fabric, satin fabric, twill fabric, non-weft fabric, non-woven fabric and non-crimp fabric; which is characterized in that: at least one surface of the basal fiber fabric is conglutinated with a toughening layer, wherein:
the toughening layer comprises a thermoplastic resin selected from the group consisting of polyetherketone, polysulfone, polyethersulfone, thermoplastic polyimide, polyetherimide, polycarbonate, polyphenylene oxide, and polyamide, or a mixture of the thermoplastic resin with a thermosetting resin selected from the group consisting of epoxy resin, bismaleic imide resin, thermosetting polyimide resin, polybenzoxazine resin, phenolic resin, cyanate resin, and unsaturated polyester resin, wherein the thermosetting resin accounts for 5-50% by weight of the mixture;
the toughening layer has an areal weight of 1-50 g/m², and a thickness of 1-50 μm; and
the toughening layer is conglutinated continuously or discretely in a certain pattern, and covers the surface of the basal fiber fabric by a percentage of ≧50%.

2. The prefabricated fabric for liquid molding composite material according to claim 1, further comprising a tackifying layer uniformly conglutinated onto a surface of the basal fiber fabric, wherein:
the tackifying layer comprises a thermosetting resin selected from the group consisting of epoxy resin, bismaleic imide resin, thermosetting polyimide resin, polybenzoxazine resin, phenolic resin, cyanate resin, and unsaturated polyester resin, or a mixture of the thermosetting resin with rubber particles, wherein the rubber particles account for 1-50% by weight of the mixture;
the areal weight of the tackifying layer is 1-30% that of the basal fiber fabric; and
the tackifying layer is conglutinated discretely in a certain pattern.

3. The prefabricated fabric for liquid molding composite material according to claim 1, wherein the toughening layer has an areal weight of 10-30 g/m², and a thickness of 10-30 μm.

4. A method for preparing the prefabricated fabric for liquid molding composite material according to claim 1, comprising the steps of:
conglutinating a toughening layer, the step of conglutination the toughening layer comprising:
preparing a precursor material of the toughening layer by making a toughening component into the form of a solution, powder, film, hot-melt adhesive or fabric, which independently exists or adheres to a supporting paper or a supporting fabric; and
conglutinating the precursor material of the toughening layer onto at least one surface of a basal fiber fabric, wherein a process of conglutinating the precursor material comprises: a solution coating method for solution when the toughening component is a solution; a hot-melt coating or powder coating method for powder when the toughening component is a powder; a film-laminating method for film when the toughening component is a film; a hot-melt coating or hot-press transfer method for hot-melt adhesive when the toughening component is a hot-melt adhesive; or a fabric laminating or hot-melt coating method for fabric when the toughening component is a fabric; to thereby form a continuous toughing layer or a discrete toughening layer in a certain pattern; and
conglutinating a tackifying layer, the step of conglutinating the tackifying layer comprising:
preparing a precursor material of the tackifying layer by making a tackifier into the form of a solution, powder, film or hot-melt adhesive, which independently exists or adheres to a supporting paper or a supporting fabric;
conglutinating the precursor material of the tackifying layer onto at least one surface of a basal fiber fabric, wherein a process of conglutinating the precursor material comprises a solution coating method for solution when the tackifier is a solution; a hot-melt coating or powder coating method for powder when the tackifier is a powder; a film-laminating method for film when the tackifier is a film; or a hot-melt coating or hot-press transfer method for hot-melt adhesive when the tackifier is a hot-melt adhesive; to thereby form a discrete tackifying layer in a certain pattern.

5. The prefabricated fabric for liquid molding composite material according to claim 2, wherein the toughening layer has an areal weight of 10-30 g/m², and a thickness of 10-30 μm.
